(19) United States
(12) Patent Application Publication
(10) Pub. No.: US 2008/0089968 A1
(43) Pub. Date: Apr. 17, 2008

(54) MOLD ASSEMBLY

(75) Inventor: Wei Yie, Hu-Pei Province (CN)

Correspondence Address: CONNOLLY BOVE LODGE & HUTZ LLP, 1875 EYE STREET, N.W., SUITE 1100, WASHINGTON, DC, 20036, US

(73) Assignees: DELTA ELECTRONICS COMPONENTS (DONGGUAN) CO., LTD., Kuang-Dong Province (CN); DELTA ELECTRONICS, INC., Taoyuan Hsien (TW)

(21) Appl. No.: 11/752,997

(22) Filed: May 24, 2007

(30) Foreign Application Priority Data
Oct. 12, 2006 (TW) 095137571

(51) Int. Cl. B28B 13/06

(52) U.S. Cl. 425/236

(57) ABSTRACT

A mold assembly is provided to manufacture an object such as a cooling fan. The cooling fan comprises a first element and a second element. The first element and the second element is preferably a frame and blades, respectively, an upper cover and a lower cover, respectively, or another couple of elements of the cooling fan. The mold assembly comprises a runner, a fixed male mold plate, a male mold core, a fixed female mold plate, and a female mold. The male mold core which is fixed on the fixed male mold plate comprises a first male mold portion and a second male mold portion both of which are connected with the runner. The female mold which is fixed on the fixed female mold plate comprises a first female mold portion and a second female mold portion. The first male portion and the first female mold portion corresponding thereto forms a first mold cavity, complementary in shape to the first element. The second male portion and the second female mold portion forms a second mold cavity, complementary in shape to the second element.

### CROSS-REFERENCES TO RELATED APPLICATIONS

Not applicable.

### BACKGROUND OF THE INVENTION

1. Field of the Invention

The present invention relates to a mold assembly for manufacturing an object, particularly a cooling fan.

2. Descriptions of the Related Art

Mechanical or electronic equipment often uses a cooling fan to quickly reduce heat and prevent the influence of accumulated heat during normal operation of the device in prior art. Therefore, a cooling fan is an indispensable component of these mechanical and electronic devices, especially those that continually produce a large amount of heat.

The components of common cooling fans comprise a frame, blades, an upper cover and a lower cover. A conventional way of producing these components is to design a set of molds for each component Every set of molds mainly comprises a mold base, a fixed male mold plate, a male mold and a male mold core disposed onto the fixed male mold plate, a fixed female mold plate, a female mold disposed onto the fixed female mold plate, and other main components. The female mold has a female mold portion corresponding to the male mold core. The female mold portion and the male mold core form a cavity, complementary in shape to each component. One of the mold base and the at least two fixed plates is formed with a cooling channel for speeding up the cooling shaping of every component after pouring the plastics.

Every component is made separately by its specific mold. Therefore, a production line needs more than four injection molding machines to produce the components for a complete cooling fan assembly. After producing the components, every component needs to be stocked in a warehouse first, then set in the production line while assembling, thus increasing the complexity of the work and the production cost.

Given the above, a mold assembly which simplifies the processes for making cooling fans needs to be developed in this field in order to simply and easily produce the components of the cooling fans, reduce cost, and avoid the disadvantages of a complex procedure.

### SUMMARY OF THE INVENTION

The primary objective of the present invention is to provide a mold assembly for manufacturing an object, such as cooling fans. Two corresponding elements of the cooling fans are produced in a mold with the present mold assembly. The mold assembly has advantages of increasing the stability of the products and cooperating with the production line to reduce the stock, cost, and time required.

The cooling fan, which is made by the mold assembly, comprises a first element and a second element. The first element and the second element can be a frame and blades, an upper cover and a lower cover, respectively, or other couple elements used in pairs. The mold assembly comprises a runner, a fixed male mold plate, a male mold core, a fixed female mold plate, and a female mold. The male mold core is disposed onto the fixed male mold plate, wherein the male mold core comprises a first male mold portion and a second male mold portion. The first male mold portion and the second male mold portion are both connected with the runner. The female mold is disposed onto the fixed female mold plate, wherein the female mold comprises a first female mold portion and a second female mold portion. The first female portion and the first female mold portion corresponding thereto form a first mold cavity, complementary in shape to the first element. The second male portion and the second female mold portion corresponding thereto form a second mold cavity, complementary in shape to the second element.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic of using the female mold portion and male mold portion in pairs of the first embodiment of the present invention;

FIG. 2 illustrates a schematic of the female mold portion for forming a frame and blades of FIG. 1;

FIG. 3 illustrates a schematic of using the female mold portion and male mold portion in pairs of the second embodiment of the present invention; and

FIG. 4 illustrates a schematic of the female mold portion for forming an upper cover and a lower cover of FIG. 3.

### DESCRIPTION OF THE PREFERRED EMBODIMENT

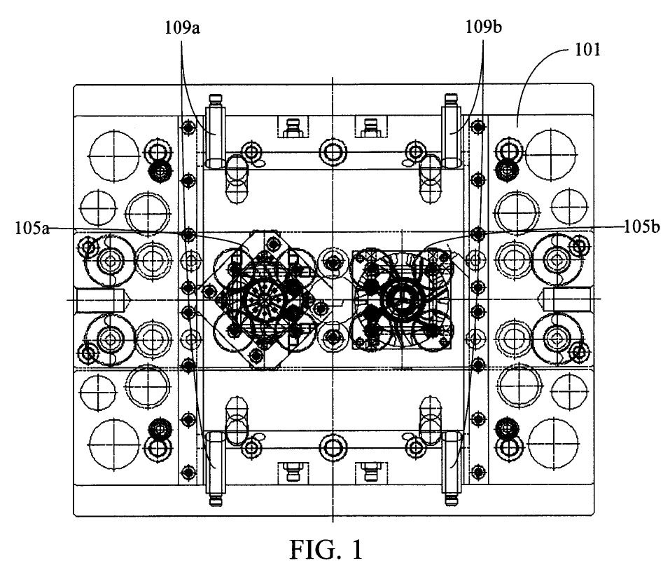

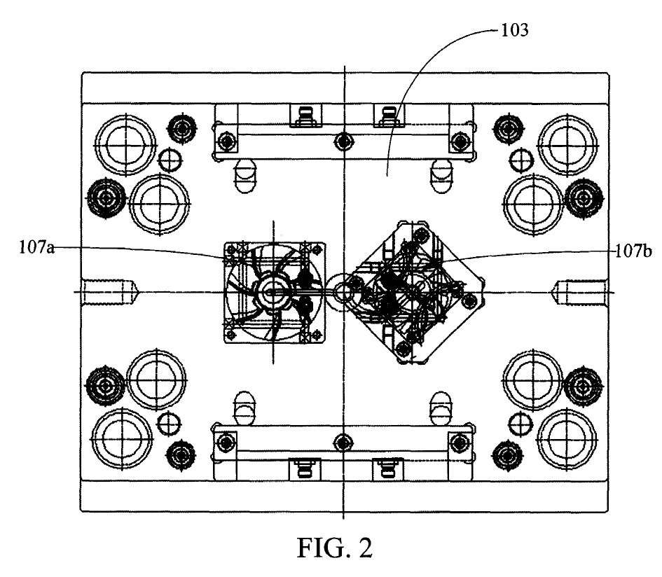

The first embodiment of the present invention discloses a mold assembly for forming cooling fans, as shown in FIG. 1 and FIG. 2. The cooling fan comprises a first element and a second element. In the first embodiment, the first element and the second element are a frame and blades disposed therein, respectively. The mold assembly comprises a runner (not shown), a fixed male mold plate 101, a male mold core, a fixed female mold plate 103, and a female mold. Furthermore, the mold assembly contains other additional elements and which are not elaborated herein.

The male mold core is disposed onto a fixed male mold plate 101, and the male mold core comprises a first male mold portion 105a and a second male mold portion 105b adjacent thereto. The male mold portion 105a and 105b are both connected with the runner (not shown). The female mold is disposed onto a fixed female mold plate 103, wherein the female mold comprises a first female mold portion 107a and a second female mold portion 107b adjacent thereto. The fixed male mold plate 101 and the fixed female mold plate 103 are both formed with a first cooling channel 109a and a second cooling channel 109b. In other embodiments, the cooling channel can be only formed on one of the fixed male mold plate 101 and the fixed female mold plate 103. The first male mold portion 105a and the first female mold portion 107a corresponding thereto form a first mold cavity (not shown), complementary in shape to the frame. The second male mold portion 105b and the second a female mold portion 107b form a first mold cavity (not shown in the figure), complementary in shape to the blades.

For the aforementioned mold assembly, the first female mold portion for forming the frame and the second female mold portion for forming the blades are substantially disposed equidistantly about a plane of symmetry.

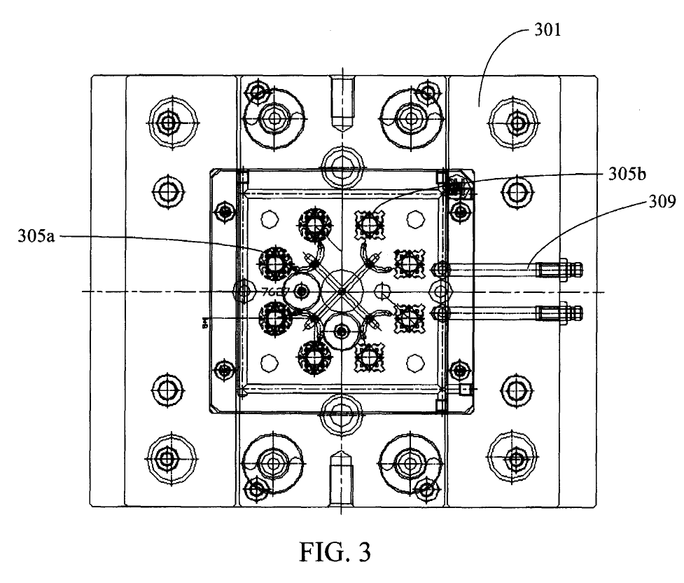

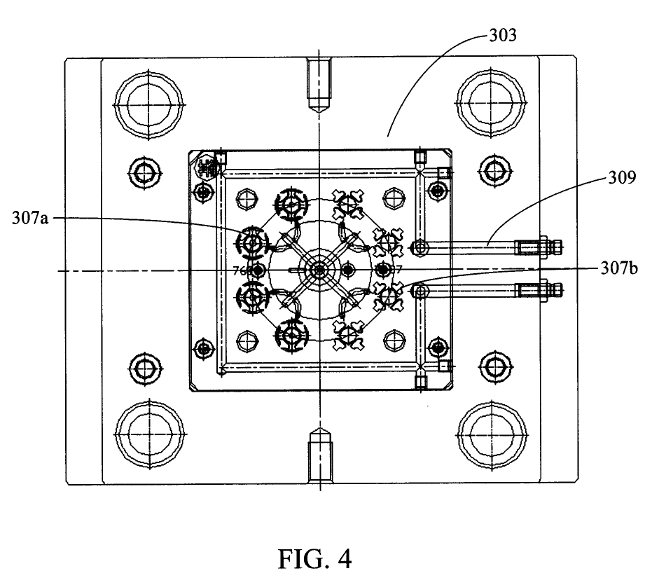

The second embodiment of the present invention discloses a mold assembly for forming cooling fans, as shown in FIG. 3 and FIG. 4. The cooling fan comprises a first element and a second element. In the second embodiment, the first element and the second element are an upper cover and a lower cover corresponded thereto, respectively. The mold assembly comprises a runner (not show), a fixed male mold plate 301, a male mold core, a fixed female mold plate 303, and a female mold. Furthermore, the mold assembly contains additional elements, which are not elaborated herein.

The male mold core, disposed onto the fixed male mold plate 301, comprises a plurality of first male mold portions 305a and a plurality of second male mold portions 305b substantially disposed equidistantly about a circumference. The first and second male mold portions 305a and 305b are all connected with the runner. The female mold, disposed onto the fixed female mold plate 303, comprises a plurality of the first female mold portions 307a and a plurality of the second a female mold portions 307b. In the second embodiment, there are four first female mold portions 307a and four second female mold portions 307b. The fixed male mold plate 301 and the fixed female mold plate 303 are both formed with a cooling channel 309. In other embodiments, the cooling channel can be only formed on one of the fixed male mold plate 301 and the fixed female mold plate 303. The first male mold portions 305a and the first female mold portions 307a corresponding thereto form a plurality of first mold cavities complementary in shape to upper cover (not show). The second male mold portion 305b and the second female mold portion 307b corresponding thereto form a plurality of second mold cavities complementary in shape to lower cover (not show). In another words, there are four upper covers and four lower covers corresponding thereto formed in the embodiment.

The four first female mold portions for forming the four upper covers and the four second female mold portions for forming the four lower covers are substantially symmetrical to each other about the same plane of symmetry.

The first and second embodiments only illustrate applications of the two corresponding elements of the present invention. Therefore, the utilization of the cooling fan elements of the present invention is not limited to the mentioned elements. Further, the utilization of the cooling fan of the present invention is also not limited to the mentioned embodiments. Other cooling fans comprising other elements all can use the basis of the present invention that is implemented.

The present invention only uses one set of a mold assembly, and makes two corresponding elements of the cooling fan. Fewer steps are required for producing elements of the cooling fan. Take the cooling fan comprising two corresponding elements, such as the frame, the blades, the upper cover, and the lower cover as an example, the present invention only utilizes two injection molding machines and two sets of a mold assembly to produce a cooling fan. The present invention simplifies the process of production arrangement and causes easy management and higher efficiency. In addition, the mold assembly has advantages of increasing the stability of the products and cooperating with the production line to reduce the stock, cost and time required.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mold assembly for manufacturing an object, the object comprising a first element and a second element, the mold assembly comprising:
a runner;
a fixed male mold plate;
a male mold core, disposed onto the fixed male mold plate, the male mold core comprising a first male mold portion and a second male mold portion, both connected with the runner;
a fixed female mold plate; and
a female mold, disposed onto the fixed female mold plate, the female mold comprising a first female mold portion and a second female mold portion,
wherein the first male portion and the first female mold portion corresponding thereto form a first mold cavity, complementary in shape to the first element, and the second male portion and the second female mold portion corresponding thereto form a second mold cavity, complementary in shape to the second element.

2. The mold assembly as claimed in claim 1, wherein the object is a cooling fan, which comprises a frame and blades disposed therein, in which the first element is the frame, and the second element includes the blades.

3. The mold assembly as claimed in claim 1, wherein the object is a cooling fan, which comprises an upper cover and a lower cover corresponding thereto, the first element is the upper cover, and the second element is the lower cover.

4. The mold assembly as claimed in claim 1, wherein at least one of the fixed male mold plate and the fixed female plate is formed with a cooling channel.

5. The mold assembly as claimed in claim 1, wherein the first female mold portion and the second female mold portion are substantially symmetrical to each other.
